(19) United States
(12) Patent Application Publication
(10) Pub. No.: US 2019/0256311 A1
(43) Pub. Date: Aug. 22, 2019

(54) PRE-SET MANUAL TAPE LENGTH TAPE DISPENSER

(71) Applicant: LAMUS TECHNOLOGIES INC., Vancouver (CA)

(72) Inventors: Joe Augustine S.T. Lam, Vancouver (CA); Jason Y-Wan Cheng, Burnaby (CA)

(21) Appl. No.: 15/902,649

(22) Filed: Feb. 22, 2018

(51) Int. Cl. B65H 16/00; B29C 65/50; B65H 35/04; B65H 37/04

(52) U.S. Cl. CPC B65H 16/005; B29C 65/5042; B29L 2031/7162; B65H 35/04; B65H 37/04; B29C 65/5092

(57) ABSTRACT

A method and the required apparatus for carrying out the manual application of a pre-set length of tape to seal a carton that uses a tape hold down and a tape dispenser. The tape dispenser stops the movement of tape being pulled therefrom when the desired pre-set length of tape has been dispensed and which is cut to provide a free tape portion is used to provide the tape portion that is to be applied manually to seal the carton. The flaps of the carton being sealed are held in place when the tape portion is being applied by a U-shaped flap holder formed by a pair of L-shaped legs that are spaced to permit application of the tape portion to the carton between the legs when the flap folder is in position holding the flaps closed.

### CROSS REFERENCE TO RELATED APPLICATIONS

Not Applicable.

### STATEMENT REGARDING FEDERALLY SPONSORED RESEARCH OR DEVELOPMENT

Not Applicable

### REFERENCE TO MICROFICHE APPENDIX

Not Applicable.

### FIELD OF INVENTION

The present invention relates to a tape dispenser, more particularly to a tape dispenser wherein the dispenser may be preset to dispense a defined length of tape by simply manually pulling a preset length of tape. The invention also relates to a carton flap holder to facilitate application of the preset length of tape dispensed by the tape dispenser. The invention also includes a method of sealing a case or carton by employing the dispenser and flap holder.

### BACKGROUND OF THE PRESENT INVENTION

The amount of on-line sales is expanding exponentially and orders so sold must, in many cases each be individually packaged and shipped to the buyer. This poses a totally different packaging situation to the heretofore convention packaging systems wherein a plurality of essentially the same size cartons are presented to the machine in a substantially constant stream and these cartons are closed and sealed by an automatic packaging machine processing many, many, cartons per minute.

Based on current technology individual cartons as required, for example, with on-line sales are in most cases sealed manually. There are many different manual tapers used to apply tapes to seal cartons most simply rely on a dispenser and an operation in which the operator manually manipulates the applicator to apply the leading end of a tape to the carton then the operator move the dispenser relative to the carton to apply the tape to the closed flaps of the case and finally manipulates the dispenser to apply the tape to an end wall of the case or carton and cut the tape after application has substantially been completed. Examples of such systems are shown in U.S. Pat. No. 9,493,322 issued Nov. 15, 2016; U.S. Pat. No. 9,546,068 issued Jan. 1, 2017; and U.S. Pat. No. 9,873,586 issued Jan. 21, 2017; all invented by Lam.

U.S. Pat. No. 5,730,827 issued Mar. 24, 1998 and U.S. Pat. No. 7,938,159 issued May 10, 2011 to Makar et al. show examples of machines for mechanically pulling a defined length of tape from a tape source and applying it to a carton to seal the flaps thereof. It is also well known to define a feed length and drive a feed roller for a time required to dispense the desired length of tape see for example US2016353945 published Dec. 8, 2016 and US20020121169 published Sep. 2, 2002 and U.S. Pat. No. 3,076,587 and PCT published application WO 00/41960 published Jul. 20, 2000 that later of which describes a system for automatically dispensing pre-selected lengths of tape that uses the rotation of an idler wheel to measure the length of tape being dispensed. Korean 20170066164 appears to disclose stopping the rotation of the supply tape roll to define the length of tape being dispensed.

The use of the tape movement to drive a generator for charging a battery is also known, see for example, U.S. Pat. No. 9,102,493 Issued Aug. 11, 2015 to Lam

Manually applying pre-cut tape lengths provided by the dispenser is a difficult task unless means are provided that may be easily and quickly applied to hold the flaps in folded position ready for taping. Applicant is not aware of any such devices having been proposed prior to the present invention. Applicant is aware of U.S. Pat. No. 3,094,827 that teaches a device for hold the flaps in closed position for stapling the flaps closed and that is not similar to the present invention other than it holds the flaps closed for sealing. U.S. Pat. No. 3,349,446 issued Oct. 31, 1967 to Haygerman discloses a L shaped flap holder to hold the flaps in open position against the outside of the box and that uses penetrating pins to hold the device in position. Another device for holding the flaps open and in contact with the outside of the box is U.S. Pat. No. 4,528,800 that use an M shape device that is positioned diagonally across a corner between a pair of adjacent sides of the box and sandwiches each of these walls against their respective attached flap.

The present invention provides a tape dispenser and method of taping that greatly facilitates and permits an operator to more quickly seal a carton or case by permitting the operator to select the required tape length and then withdraw this a pre-selected length of tape from the dispenser and then manually apply same to a case or carton with the flaps held in taping position by the flap holder of forming part of the invention.

### BRIEF DESCRIPTION OF THE PRESENT INVENTION

It is an object of the present invention to provide a manually powered tape dispenser to dispense a pre-set tape length and a flap holder that facilitate a method for the manual application of an adhesive tape to seal the flaps of a case or carton.

Broadly the present invention relates to a method for manually sealing carton comprising folding pair of opposed flaps of said carton into closed position with their adjacent end edges in close proximity, applying a flap holder comprised of a U shaped member having pair of spaced L shaped legs to said flaps adjacent to one end wall of said carton and so that a flap engaging portion at one end of one of said legs rests upon an adjacent one of said pair of flaps and a flap engaging portion of another of said legs rests on another of said flaps, said spaced legs being applied to provide a tape application space exposing said end edges therebetween and with an opposite end of each said leg contacting said one end wall of said carton, setting a sealing length of tape, manually pulling tape from a tape dispenser, activating a brake to stop movement of said tape in accordance with said setting of said sealing length, cutting said tape to provide free tape portion equal in length to said sealing length of tape, manually grasping said free tape portion adjacent to remote ends of said free tape portion and manually applying said free tape portion to said carton in said tape application space and in overlying relationship to said end edges.

The present invention also includes a manually operated tape dispenser comprising,

a tape source providing sealing tape, a cut-off knife,

a tape path extending between said tape source and said cut-off knife,

a tape feed measuring roll positioned along said path, said tape feed measuring roll engaging with said sealing tape to control travel of said sealing tape along said path,

a signal generator driven by said tape feed measuring roll and generating a tape length signal representative of length of tape measured by said tape feed measuring roll,

a microprocessor receiving said tape length signal of length,

an input device connected to said microprocessor for inputting a desired tape length of said tape,

a brake to stop movement of said tape feed measuring roll and thereby said dispensing of said tape,

said microprocessor actuating said brake when said length of tape measured by said tape feed measuring roll equals said desired tape length.

Preferably said sealing tape has an adhesive side and said tape path is configured so that said adhesive side of said sealing tape contacts a periphery of said tape feed measuring roll

Preferably, said signal generator includes a pulse generator that generates a pulse for each increment of rotation of said tape feeding roll and a pulse counter to count said pulses to provide said tape length signal.

Preferably said manually operated tape dispenser further comprising batteries for powering said brake and microprocessor and a power generator driven by rotation of said tape feed measuring roll connected to said batteries to provide power to recharge said batteries.

Another part of the present invention comprises a flap holder for holding flaps of a carton to be sealed by a tape in closed position comprising a pair of spaced L-shaped legs interconnected at one end by a bridging member to define a U-shaped member that provides an open space between said legs to permit application of tape to seal flaps of said carton, said L-shape defining a flap engaging portion adjacent to a free end of each of said legs and a carton wall engaging portion adjacent to said bridging member.

Preferably an angle forming each said leg into said L-shape with said legs in relaxed position being less than 90° and said legs each being resiliently deformable to an extended position wherein said angle is increased to 90° when said flap holder is holding said flaps in a taping position, a first set of anchor pins projecting from each said leg adjacent to a free end of each said leg and angled toward said bridging member and positioned to engage with said flaps when said flap holder is in flap holding position, a second set of anchor pins projecting from said U-shaped member adjacent to said one end of each of said legs, said second set of anchor pins being angled toward said free ends and positioned to engage an adjacent wall of said carton when said holder is flap holding position.

Preferably the flap folder further comprising an operating handle project from said bridging member in a direction substantially opposite to said second set of anchor pins.

### BRIEF DESCRIPTION OF THE SEVERAL VIEWS OF THE DRAWINGS

Further features, objects and advantages will be evident from the following detailed description of the preferred embodiments of the present invention taken in conjunction with the accompanying drawings in which;

FIG. 1 is a side elevation with parts omitted showing the tape path through the applicator and the main elements that make up the operating parts of the tape dispenser.

FIG. 2 is a schematic illustration of the operation and control systems of the dispenser.

FIG. 3 is an isometric view of the flap hold down of the present invention.

FIGS. 4A and 4B are end views showing the preferred way of positioning the flap hold down to best ensure the flaps of the carton being sealed are securely and properly positioned for application of the sealing tape, FIG. 4 A showing the first stage of application and FIG. 4B the holder in flap securing position for tape application.

FIGS. 5A, 5B, 5C and 5D illustrate the various steps in sealing the carton and showing respectively the carton with the flaps open, the carton with the flaps folded in closed position, the flap holder in position holding the flaps for taping and an operator represented by hands holding the tape portion to be applied in position to apply the tape.

FIG. 6 shows the steps for carrying out the method of the present invention.

### DETAILED DESCRIPTION OF THE INVENTION

The dispenser 10 is composed of a housing or frame 12 that mounts a hub or mandrel 14 on which a roll 16 of adhesive tape 18 to be dispensed is mounted. Also mounted on the housing 12 is a tape feed measuring roll 20 and a guide roll 22 that are relatively position to guide the tape 18 on a tape path 24 so that the adhesive side 26 of the tape 18 is applied against the periphery 28 of the tape feed measuring roll 20 to ensure there is essentially no slippage between the ape 18 and the periphery 28 of the roll 20.

The tape path 24 extends from the periphery 28 of roll 20 to a tape support lever 30 pivotably mounted on the frame or housing 12 as indicated by axel 32 and biased to an up-position (as illustrated), as shown, by a spring 34 extending between an arm 36 of the lever 30 and the frame 12. A cut-off knife 38 is mount on the frame 12 in a position to cut the tape 18 when the tape 18 and thereby the support lever 30 are pull down to force the tape against the knife 38 and sever the tape 18.

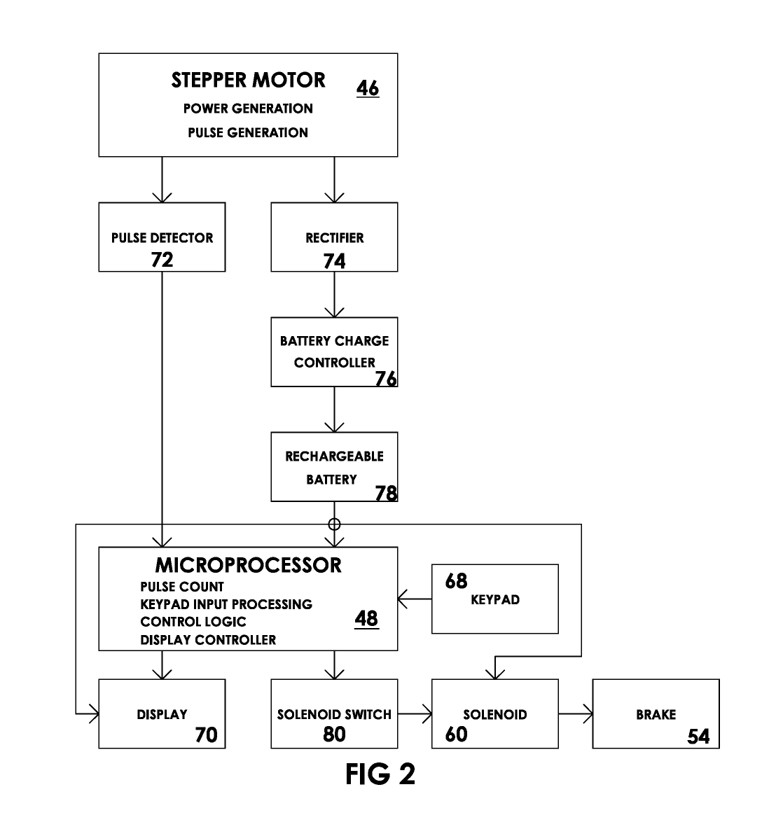

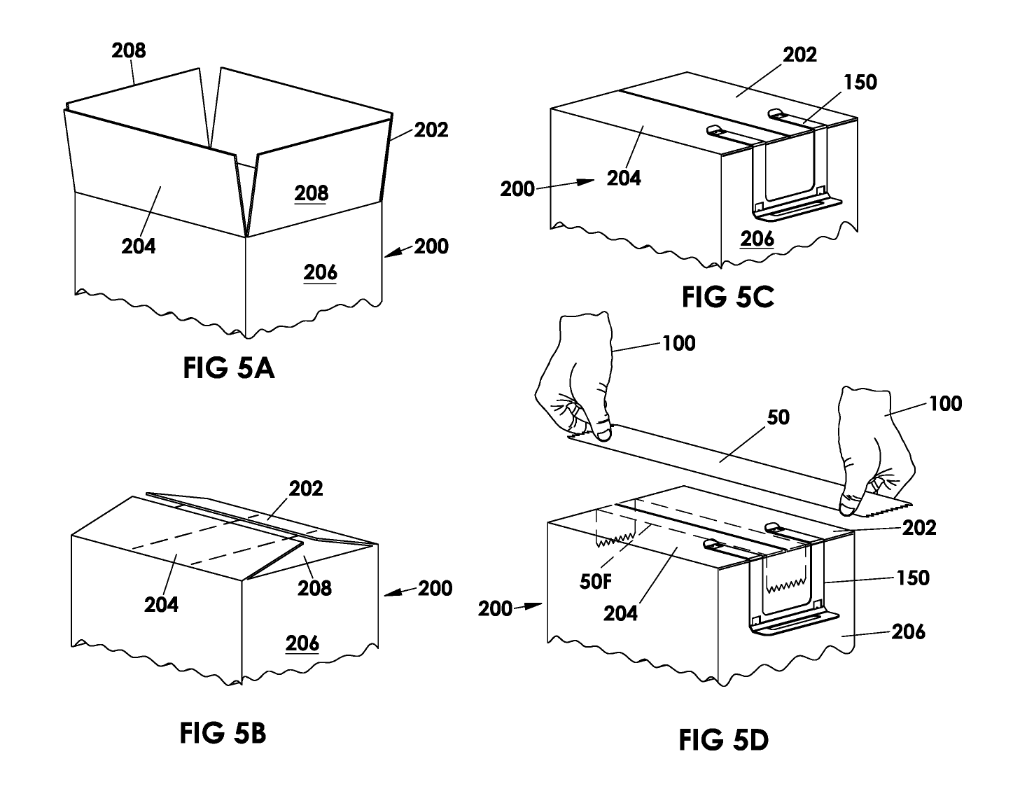

In order to measure the length of tape 18 being dispensed the tape measuring roll has a primary gear 40 attached to rotate therewith and 40 meshes with secondary gear 42 mounted to drive the shaft 44 of a stepper motor 46 also mounted on the frame 12 and which generates a tape length signal as the roll 20 is rotated. This signal and other information are delivered to a microprocessor 48 and used to set the tape length i.e. the length at which the tape is to be dispensed and cut to form a tape potion 50 as shown in FIGS. 2 and 5D and as will be described below.

Also mounted on the frame or housing 12 is a brake or latch 52 which in the illustrated arrangement takes the form a lever 54 pivotably mounted on frame 12 as indicated at 56 and biased to a release position as illustrated by a spring 58. The lever 54 is provided with gear teeth 59 positioned to mesh with the teeth of primary gear 40 when forced in stopping or latching position by the action of solenoid 60 the operation of which is triggered by the microprocessor 48 and thereby stop rotation of the roll 20.

The lines 62 and 64 represent the connections between the microprocessor 48 and the stepper motor 46 and solenoid 60 to deliver the required signals.

A controller 66 is also mounted on the frame 12 in a position for convenient access by the operator to the keyboard 68 which is used to input the desired length of the free tape portion 50 and display 70 to facilitate operation of the dispenser. The housing for the controller preferably will also contain the microprocessor 48 and other elements of the control system to produce a tape portion 50 of to pre-set length.

Turning to FIG. 2 the operation and elements of the preferred form of control and braking system of dispenser will be described. The Stepper motor 46 as indicated is used to generate power for recharging and pulses for defining tape length as it is pulled from the tape roll 16. The pulses each represent a specific degree of rotation of the roll 20 and thus define an increment of travel of the tape 18 i.e. a specific increment of length. These pulses are detected as illustrated at 72 and used to provide a pulse count (length of travel of the tape 18) in the microprocessor 48.

The power generated by the step motor 48 is rectified s indicated at 74 and fed to a battery charge controller 76 and used to charge the rechargeable batteries 78 the power from which is used to power the microprocessor 48.

The keyboard 68 is used by the operator to define the length of the tape portion 50 to be dispensed and cut-off by the operator and this information is fed from the keyboard 68 to the microprocessor 48 where it is correlated with the length as defined by the pulse count in the microprocessor 48 which at the appropriate correlation to the length as inputted from the keyboard triggers the solenoid switch 80 which triggers solenoid 60 and thereby the brake 52 to stop rotation of the roll 20 and thereby movement of the tape 18. The solenoid switch 80 is a timing circuit, i.e. a programmable timer in the microprocessor which turns off the solenoid 60 after a preset time delay (normally 0.5 second delay) and then the spring 58 retracts the arm 54 to disengage the brake 52 by disengaging the teeth 59 from the teeth 40 to permit withdrawl on the next tape portion 50.

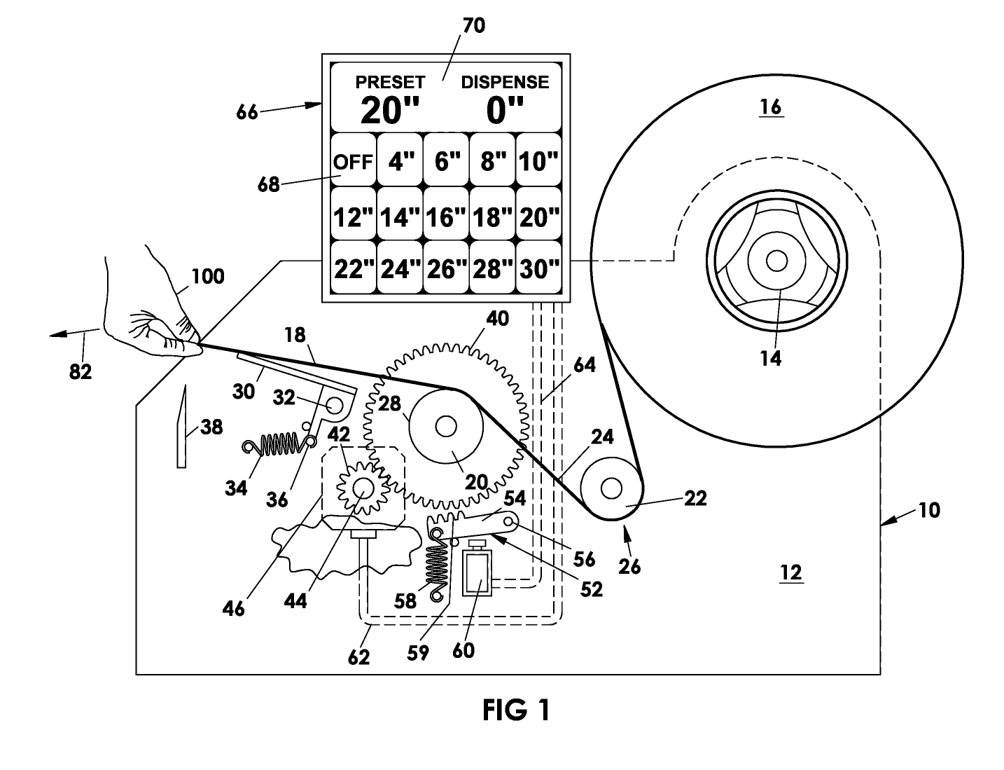

The preset length of the tape to be dispensed once set by input via the keyboard 68 remain as the length until changed by inputting a new length applied via the keyboard 68. The then current preset tape length is displayed via the display 70 see FIG. 1. It will be apparent that the sole source of power is the operator as represented by the hands 100 (see FIGS. 1 and 5D) so that when the operator pulls the tape 58 as indicated by the arrow 82 (FIG. 1) causes the roll 20 and thus the stepper motor 46 to be rotated and generate the required pulses as detected by the pulse detector 72 and the power that is used for charging the batteries 78.

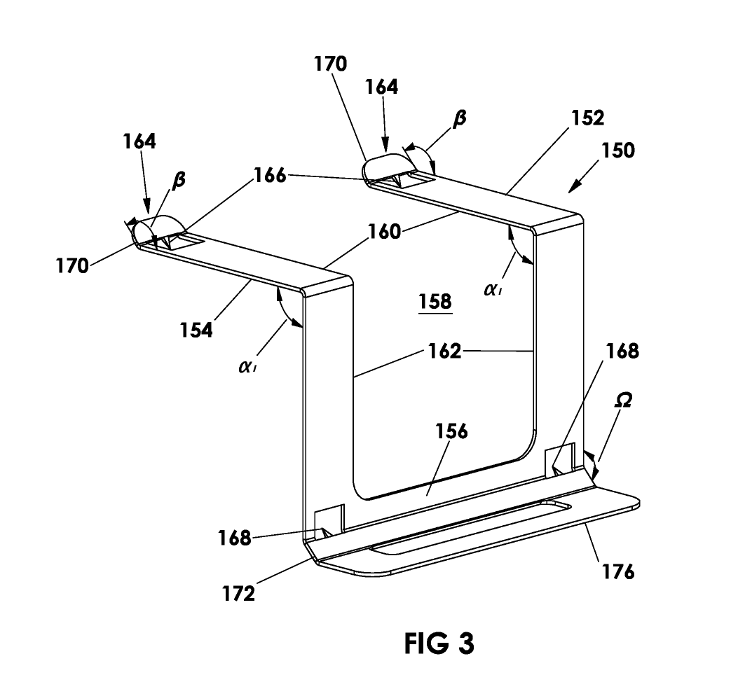

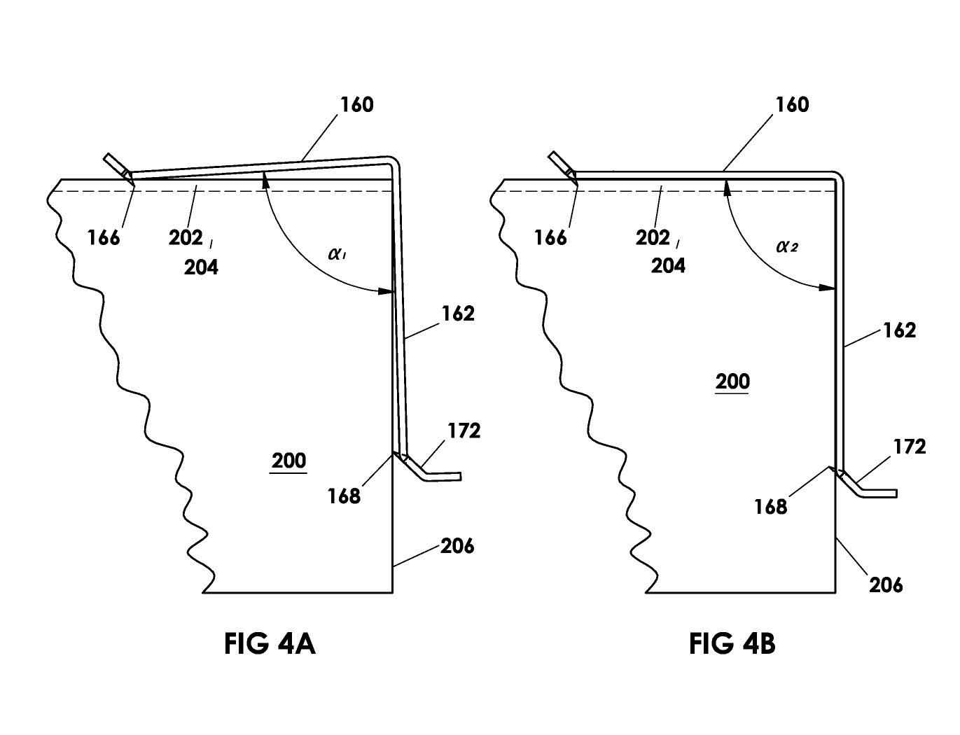

To facilitate the manual application of the preselected length tape portion 50 provided by the dispenser 10 to seal a case or carton 200 it is necessary to hold the opposed outer case or carton flaps 202 and 204 of the case or carton 200 (see FIGS. 4A, 4B and clearer in FIGS. 5A, 5B and 5C) in folded closed position as seen in FIGS. 4A, 4B, 5C and 5D. This is easily done by applying the flap holder or flap hold down 150 the preferred embodiment of which is shown in an isometric view in FIG. 3.

The flap hold down or holder 150 for holding flaps of a carton or case (the term carton is intended to include case and vice versa) to be sealed is form by a pair of spaced L-shaped legs 152 and 154 interconnected at one end by a bridging member 156 to define a U-shaped member which in effect defined the shape of the holder 150 that provides an open space 158 between said legs 152 and 154 to permit application of tape to seal flaps 202 and 204 of said carton 200 as will be described below. Each of the legs 152 and 154 is provided with a flap engaging portion 160 and an adjacent wall engaging portion 162. Each flap engaging portion 160 is adjacent to the free end 164 of its leg 152 or 154 and each wall engaging portion 162 is adjacent to the bridging member 156 and in effect are interconnected to form the L-shape of the legs 152 and 154.

The angle α₁ between the portions 160 and 162 forming each leg 152 and 154 into the L-shape with said legs in relaxed initial position at first stage of application shown in FIG. 4A is less than 90°. When the holder 150 is moved to the flap securing position shown in FIG. 4B ready for tape application the holder is deformed and the angle α₁ is increased to angle α₂ which matches the corner angle of the closed case or carton 200 i.e. between the outer flaps 202 or 204 (one at each side of the carton 200) and the adjacent side wall 206 of the carton 200 (see FIGS. 5C and 5D) and will be about 90° to connect the holder 150 and hold the flaps 202 and 204 in position for tape application. In this position the top or flap anchor pins 166 (one adjacent to the free end of each leg 152 and 154) penetrate into their adjacent outer flap 202 and 204 and side anchor pins 168 positioned adjacent to the connecting member 156 penetrating the adjacent side panel 206 of the case or carton 200 as will be further described. Deforming the holder to change α₁ to α₂ ensure the pins 1 maintains pressure between the holder and the carton or case to keep the flap holder 150 in position until removed by the operator 100.

In practice applicant has found that angle α₁ when the holder 150 is made of spring steel can be about 88°.

As shown in most detail in FIG. 3 the holder 150 is formed with flanges 170 extending at an angle β one from the free end 164 of each of the legs 152 and 154. In the illustrated arrangement the anchor pins 166 are each in the same plane as their adjacent flange 170. The side anchor pins 168 are formed in a similar way and are in the same plane as flange which extend from the bridging member 156 at an angle Ω. The holder 150 is also provided with a handle member 176 that projects from the side of the flange 172 remote from the bridging member 156. The two angles β and Ω will preferably each be about 120°, which will make the anchor pins 166 and 168 inclined to a penetrating angle of about 60° to the corrugated surfaces of the flaps 202 and 204 and wall 206. i.e. The pins in effect are pointing toward each other and are sized prevent relative movement i.e. hold the flaps in place as the tape portion 50 is applied.

It is also possible to employ a hold down (not separately shown) that uses essentially the same U-shape member with L-shaped legs as shown at 150 but without the anchor pins provided the total weight of the member is sufficient to hold the flaps 202 and 204 in position s shown in FIG. 5C

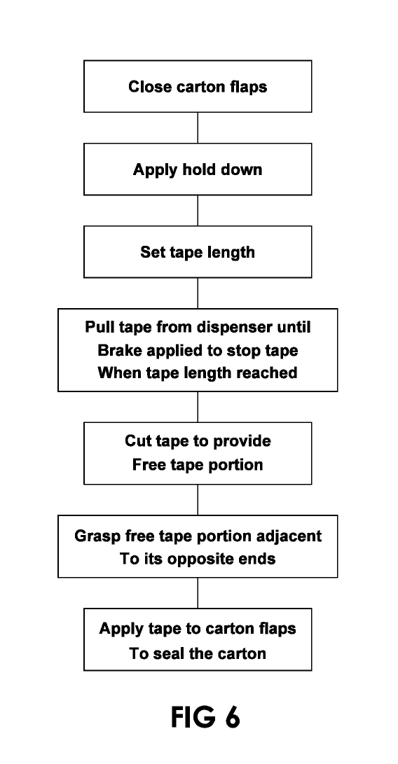

The various forms of equipment i.e. the dispenser 10 and flap holder or hold down 150 used to tape seal a case or carton has been described above, the preferred method of using equipment will now be described with reference to FIGS. 5A, 5B, 5C and 5D illustrating the various steps and FIG. 6 showing the method as a series of steps. FIG. 5A show a squared carton or filed case 200 with the top or outer flaps 202 and 204 and inner flaps 208 open and extending upward from their respective side wall or end walls (only end wall 206 has been specifically identified by number). In FIG. 5B the closing operation is almost completed with the inner flaps 208 (one at each end of the carton 200) folded inward to about 90° relative to their adjacent end wall and the outer flaps 202 and 204 folded into an overlying position. In FIG. 5C the outer flaps 202, 204 have been fold to be perpendicular to the walls of the carton 200 and the holder 150 as applied by the operator 100 as described above with reference to FIG. 4A and 4B is in the holding position illustrated in FIG. 4B.

The tape portion 50 dispensed by the dispenser 10 is then manually delivered and applied to the flaps and into the final sealing position illustrated 5OF shown in dash lines in FIG. 5D. The method or process of this invention is illustrated schematically in FIG. 6. As illustrated the carton 200 is first closed and then the hold down 150 is applied (see also) FIG. 5C. The pre-set length for the for the free tape portion 50 to be used to seal the carton 200 is set using the keypad 66 (this may be done either before or after the carton is closed and the holder 150 applied). After the tape length has been set the tape 18 is pulled manually from the dispenser 10 until the brake 52 is applied to stop the travel of the tape 18 when the preset length has been dispensed and then the operator cuts the tape using knife 38 and provide the free tape portion 50 used to seal the carton 200. The operator 100 then gaps the free tape portion 50 adjacent to its opposite ends and manually applies it to the flaps 202 and 204 and to the end walls (only one shown at 206) to seal the carton 200.

Having described the invention, modifications will be evident to those skilled in the art without departing from the scope of the invention as defined in the appended claims.

We claim:

1. A method for manually sealing carton comprising folding pair of opposed flaps of said carton into closed position with their adjacent end edges in close proximity, applying a flap holder comprised of a U shaped member having pair of spaced L shaped legs to said flaps adjacent to one end wall of said carton and so that a flap engaging portion at one end of one of said legs rests upon an adjacent one of said pair of flaps and a flap engaging portion of another of said legs rests on another of said flaps, said spaced legs being applied to provide a tape application space exposing said end edges therebetween and with an opposite end of each said leg contacting said one end wall of said carton, setting a sealing length of tape, manually pulling tape from a tape dispenser, activating a brake to stop movement of said tape in accordance with said setting of said sealing length, cutting said tape to provide free tape portion equal in length to said sealing length of tape, manually grasping said free tape portion adjacent to remote ends of said free tape portion and manually applying said free tape portion to said carton in said tape application space and in overlying relationship to said end edges.

2. A manually operated tape dispenser comprising, a tape source providing sealing tape, a cut-off knife, a tape path extending between said tape source and said cut-off knife, a tape feed measuring roll positioned along said path, said tape feed measuring roll engaging with said sealing tape to control travel of said sealing tape along said path, a signal generator driven by said tape feed measuring roll and generating a tape length signal representative of length of tape measured by said tape feed measuring roll, a microprocessor receiving said tape length signal, an input device connected to said microprocessor for inputting a desired tape length of said tape, a brake to stop movement of said tape feed measuring roll and thereby said dispensing of said tape, said microprocessor actuating said brake when said length of tape measured by said tape feed measuring roll equals said desired tape length.

3. The manually operated tape dispenser as defined in claim 2 wherein said sealing tape has an adhesive side and said tape path is configured so that said adhesive side of said sealing tape contacts a periphery of said tape feed measuring roll.

4. The manually operated tape dispenser as defined in claim 2 wherein said signal generator includes a pulse generator that generates a pulse for each increment of rotation of said tape feeding roll and a pulse counter to count said pulses to provide said tape length signal.

5. The manually operated tape dispenser as defined in claim 3 wherein said signal generator includes a pulse generator that generates a pulse for each increment of rotation of said tape feeding roll and a pulse counter to count said pulses to provide said tape length signal.

6. A manually operated tape dispenser as defined in claim 2 further comprising batteries for powering said brake and microprocessor and a power generator driven by rotation of said tape feed measuring roll connected to said batteries to provide power to recharge said batteries.

7. A manually operated tape dispenser as defined in claim 3 further comprising batteries for powering said brake and microprocessor and a power generator driven by rotation of said tape feed measuring roll connected to said batteries to provide power to recharge said batteries.

8. A manually operated tape dispenser as defined in claim 4 further comprising batteries for powering said brake and microprocessor and a power generator driven by rotation of said tape feed measuring roll connected to said batteries to provide power to recharge said batteries.

9. A flap holder a flap holder for holding flaps of a carton to be sealed by a tape in closed position comprising a pair of spaced L-shaped legs interconnected at one end by a bridging member to define a U-shaped member that provides an open space between said legs to permit application of tape to seal flaps of said carton, said L-shape defining a flap engaging portion adjacent to a free end of each of said legs and a carton wall engaging portion adjacent to said bridging member.

10. A flap holder for holding flaps of a carton to be sealed by a tape in closed position as defined in claim 9 wherein an angle forming each said leg into said L-shape with said legs in relaxed position being less than 90° and said legs each being resiliently deformable to an extended position wherein said angle is increased to 90° when said flap holder is holding said flaps in a taping position, a first set of anchor pins projecting from each said leg adjacent to a free end of each said leg and angled toward said bridging member and positioned to engage with said flaps when said flap holder is in flap holding position, a second set of anchor pins projecting from said U-shaped member adjacent to said one end of each of said legs, said second set of anchor pins being angled toward said free ends and positioned to engage an adjacent wall of said carton when said holder is flap holding position.

11. A flap holder for holding flaps of a carton to be sealed by a tape in closed position as defined in claim 9 further comprising an operating handle project from said bridging member in a direction substantially opposite to said second set of anchor pins.

12. A flap holder for holding flaps of a carton to be sealed by a tape in closed position as defined in claim 10 further comprising an operating handle project from said bridging member in a direction substantially opposite to said second set of anchor pins.
